(19) United States
(12) Patent Application Publication
(10) Pub. No.: US 2025/0169484 A1
(43) Pub. Date: May 29, 2025

(54) MEMBRANE COVERED ATTRACTANT POD

(71) Applicant: American Insect Attractants LLC., Jamestown, RI (US)

(72) Inventors: Sam LIU, Pleasant Hill, CA (US); Raymond W. IANNETTA, Jamestown, RI (US); Miaoyong CAO, Warwick, RI (US)

(73) Assignee: American Insect Attractants LLC., Jamestown, RI (US)

(21) Appl. No.: 18/957,094

(22) Filed: Nov. 22, 2024

Related U.S. Application Data
(60) Provisional application No. 63/604,082, filed on Nov. 29, 2023.

(51) Int. Cl. A01M 1/02; A01M 1/10

(52) U.S. Cl. CPC A01M 1/02; A01M 1/10; A01M 2200/01

(57) ABSTRACT

A pod includes a receptacle having a compartment configured to house an insect attractant, a membrane designed to fit over the top of the receptacle, and a removable foil lid designed to fit over the top of the membrane.

### CROSS-REFERENCE TO RELATED APPLICATION

The present application claims priority benefit of U.S. Provisional Application No. 63/604,082, filed Nov. 29, 2023, which is herein incorporated by reference in its entirety.

### BACKGROUND OF THE INVENTION

The present invention relates generally to insect lures, and more particularly to a membrane covered attractant pod.

In general, insect lures (attractants) are employed to detect, eliminate and monitor for the presence of insects that respond to lure-baited traps, such as for example, the Mediterranean fruit fly, melon fly, codling moth, mosquito, and so forth. Responding insects, on detecting a lure scent, fly until they locate the trap, enter it, and are caught.

### SUMMARY OF THE INVENTION

The following presents a simplified summary of the innovation in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

In an aspect, the invention features an article of manufacture including a receptacle having one or more compartments, a breathable fabric or membrane designed to fit over the top of the receptacle, and a removable foil lid designed to fit over a top of the breathable fabric or membrane.

In another aspect, the invention features a pod including a receptacle having a compartment configured to house an insect attractant, a membrane designed to fit over the top of the receptacle, and a removable foil lid designed to fit over the top of the membrane.

Embodiments may have one or more of the following advantages.

The breathable membrane can finely control a release rate of the chemicals inside the pod by eliminating sized die cut holes in the removable foil lid, and eliminating a need for the consumer to poke holes through the removable foil lid into the sealed media below.

A breathable fabric or membrane hole size can be tailored to a molecule size of the chemicals used in the pod.

The present invention provides a cost savings since a cap is no longer be needed on the pod.

In essence, the breathable fabric or membrane enables lower cost, finely controlled release rates (affording better catch rates) and ease of customer use.

These and other advantages of the invention will be further understood and appreciated by those skilled in the art by reference to the following written specification, claims and appended drawings.

### BRIEF DESCRIPTION OF DRAWINGS

FIG. 1 is a diagram of an exemplary membrane covered attractant pod.

### DETAILED DESCRIPTION OF THE PREFERRED EMBODIMENT(S)

It is to be understood that the specific devices and processes illustrated in the attached drawings and described in the following specification are exemplary embodiments of the inventive concepts defined in the appended claims. Hence, specific dimensions and other physical characteristics relating to the embodiments disclosed herein are not to be considered as limiting, unless the claims expressly state otherwise.

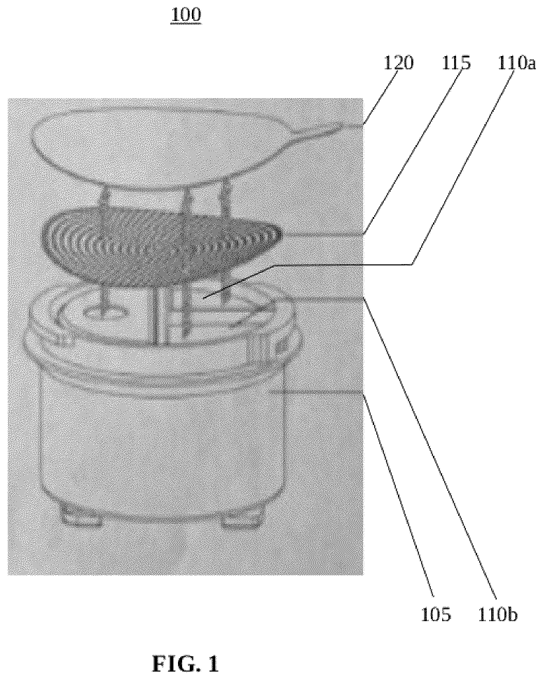

As shown in FIG. 1, an exemplary membrane covered attractant pod 100. The pod 100 is designed to attract and trap insects by using scents that mosquitoes and other biting insects find irresistible. More specifically, the pod 100 is used to attract biting insects including mosquitoes, black flies, green heads and so forth.

The pod 100 includes, for example, a receptacle 105 having one or more compartments 110a, 110b. Although two compartments 110a, 110b are illustrated here, other implementations may include more compartments or less compartments. The one or more compartments 110a, 110b are covered by a breathable fabric 115 designed to fit over the top of the receptacle 105, and a removable foil lid 120 designed to fit over the breathable fabric 115.

Different insect attractants may be housed in the one or more compartments 110a, 110b. For example, attractants may include dry ice, pheromones, octenol, and so forth.

Octenol (1-Octen-3-ol) is an Environmental Protection Agency (EPA) registered secondary mosquito attractant that mimics human breath.

Pheromones are chemicals used by insects and other animals to communicate with each other. Insects send these chemical signals to help attract mates, warn others of predators, or find food. Using specific pheromones, traps can be used to monitor target pests in agriculture or in residential areas.

Dry ice is the solid phase of CO₂. At room temperature, it changes (a process called sublimation) into CO₂ gas, which attracts insects.

The breathable fabric 115 may be constructed of, for example, nonwoven polyethylene (PE) fibers, polypropylene (PP) fibers, polytetrafluoroethylene (PTFE) fibers, and so forth. In a preferred embodiment, the breathable fabric 115 is water repellent.

The removable foil lid 120 is designed to seal the one or more compartments 110a, 110b when, for example, hot pressed over the receptacle 105. When the removable foil lid 120 is peeled off the receptacle 105, insect attractants in the one or more compartments 110a, 110b in the receptacle 105 are vaporized through the breathable fabric 115 to attract insects to a designed insect trap (not shown).

In the foregoing description, it will be readily appreciated by those skilled in the art that modifications may be made to the invention without departing from the concepts disclosed herein. Such modifications are to be considered as included in the following claims, unless the claims by their language expressly state otherwise.

What is claimed is:

1. An article of manufacture comprising:
a receptacle having one or more compartments;
a breathable fabric or membrane designed to fit over the top of the receptacle; and
a removable foil lid designed to fit over a top of the breathable fabric or membrane.

2. The article of manufacture of claim 1 wherein the one or more compartments are configured to house one or more insect attractants.

3. The article of manufacture of claim 2 wherein one or more insect attractants includes dry ice.

4. The article of manufacture of claim 2 wherein one or more insect attractants includes pheromones.

5. The article of manufacture of claim 2 wherein one or more insect attractants includes 1-Octen-3-ol.

6. The article of manufacture of claim 1 wherein the breathable fabric is manufactured from nonwoven polyethylene (PE) fibers.

7. The article of manufacture of claim 1 wherein the breathable fabric is manufactured from polypropylene (PP) fibers.

8. The article of manufacture of claim 1 wherein the breathable fabric is manufactured from polytetrafluoroethylene (PTFE) fibers.

9. The article of manufacture of claim 1 wherein the breathable fabric is water repellent.

10. A pod comprising:
a receptacle having a compartment configured to house an insect attractant;
a membrane designed to fit over the top of the receptacle; and
a removable foil lid designed to fit over the top of the membrane.

11. The pod of claim 10 wherein the insect attractant is dry ice.

12. The pod of claim 10 wherein the insect attractant is a plurality of pheromones.

13. The pod of claim 10 wherein the insect attractant is 1-Octen-3-ol.

14. The pod of claim 10 wherein the membrane comprises a breathable fabric.

15. The pod of claim 14 wherein the breathable fabric is manufactured from nonwoven polyethylene (PE) fibers.

16. The pod of claim 14 wherein the breathable fabric is manufactured from polypropylene (PP) fibers.

17. The pod of claim 14 wherein the breathable fabric is manufactured from polytetrafluoroethylene (PTFE) fibers.

18. The pod of claim 14 wherein the breathable fabric is water repellent.
